(19) United States
(12) Patent Application Publication
(10) Pub. No.: US 2009/0221328 A1
(43) Pub. Date: Sep. 3, 2009

(54) METHOD FOR OPERATING A MOBILE COMMUNICATIONS SYSTEM AND CORRESPONDING SYSTEM MOBILE COMMUNICATIONS SYSTEM

(76) Inventors: Torsten Schumacher, Königswinter (DE); Andreas Kotulla, Sankt Augustin (DE); Christoph Mause, Köln (DE)

Correspondence Address: BROWDY AND NEIMARK, P.L.L.C.;624 NINTH STREET, NW, SUITE 300, WASHINGTON, DC, 20001-5303, US

(21) Appl. No.: 12/093,184

(22) PCT Filed: Nov. 3, 2006
(86) PCT No.: PCT/EP2006/010578

§ 371 Date: Oct. 27, 2008

(30) Foreign Application Priority Data
Nov. 9, 2005 (DE) 10 2005 053 783.9

(51) Int. Cl. H04B 1/38

(52) U.S. Cl. 455/558

(57) ABSTRACT

The invention relates to a method and device for operating a mobile communications system, which comprises a multitude of radio cells and at least one mobile communications terminal with a subscriber identification module, the operation ensuing according to the whereabouts of the communications terminal. According to the invention, at least one subscriber area is established within a geographic total area covered by the mobile communications system and determines those radio cells that are located at least partially within the subscriber area. The cell identifications of the determined radio cells are transmitted to the communications terminal and subscriber identification module of the subscriber and are stored there. A comparison then ensues of the correspondence of the cell identifications of the radio cells, which currently sense the communications terminal, with the cell identifications stored in the subscriber identification module whereby, if appropriate, a special operating mode is switched to that is assigned to the subscriber area.

The invention relates to a method for operating a mobile communications system, which comprises a multitude of radio cells and at least one mobile communications terminal with a subscriber identification module, the operation ensuing according to the whereabouts of the communications terminal. The invention additionally relates to a mobile communications system for implementation of this method.

In mobile radio communications, it is known to assign to the mobile telephone subscribers an individual subscriber area, the so-called home zone. The home zone corresponds to a defined geographic area, usually the immediate environs of the subscriber's place of residence, in which the subscriber can make telephone calls at particularly favorable conditions. Provision is made in this context to indicate to the subscriber on the communications terminal when he located is within the home zone, for example in the form of a home-zone symbol. When this home-zone symbol is displayed on the communications terminal, the subscriber knows that he can make telephone calls at a more favorable tariff. The known methods are based on geographic data, which are broadcast via CBC (cell broadcast), analyzed in the communications terminal, and compared with the geographic location of the subscriber's place of residence. Geographic location data is being broadcast by base stations (fixed radio stations) of the mobile radio communications system. This solution is technically complex, as a check must be performed in the communications terminal, as to whether the geographic location of the base station corresponds with the area, data of the home zone.

It is the object of the invention to provide a mobile communications system and method for operating the same that permits a simple and reliable verification whether a communications terminal is located within a certain subscriber area, at which time corresponding actions may be initiated if appropriate.

This object is met according to the invention with a method having the characteristics of claim 1 and a device having the characteristics of claim 13.

Preferred embodiments and advantageous improvements of the invention are disclosed in the dependent claims.

In accordance with the invention. at least one subscriber area is established within a total geographic area covered by the mobile communications system, and those radio cells are determined that are located at least partially within the subscriber region. The cell identifications of the determined radio cells are transmitted to the communications terminal and subscriber identification module of the subscriber and stored there. A comparison then takes place to determine whether the cell identifications of the radio cells that currently serve the communications terminal correspond with the cell identifications stored in the subscriber identification module, at which time, if appropriate, a special operating mode is switched on that is assigned to the subscriber area.

The invention permits the visualization on a mobile communications terminal of its location within certain freely definable geographic areas—also called subscriber areas—of a mobile communications network, without using the cell broadcast service. No broadcast of special geographic location data of the base stations is needed, like it is the case with other known methods, e.g., broadcasting of the geographic location of the base station via cell broadcast.

Additionally, it is possible with the invention to establish any desired number of geographically different subscriber areas without additional technical expenditure, as the base stations do not need to be located in a contiguous area. With the conventional technology by means of cell broadcasting and transmission of geographic coordinates, this is possible only if the program code (applet) on the communications terminal or subscriber identification module supports multiple geographic zones.

A simple exemplary embodiment of the invention will be described in more detail below, in conjunction with the drawings.

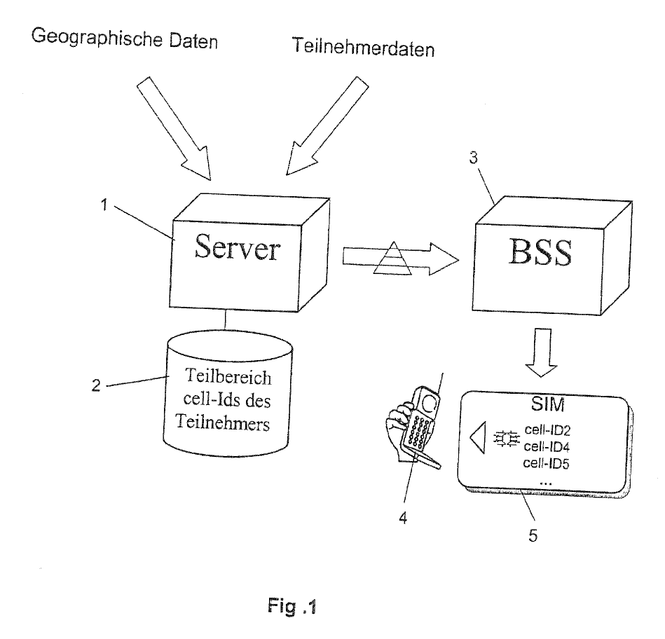

FIG. 1 shows a block diagram of the inventive system and of its most significant components.

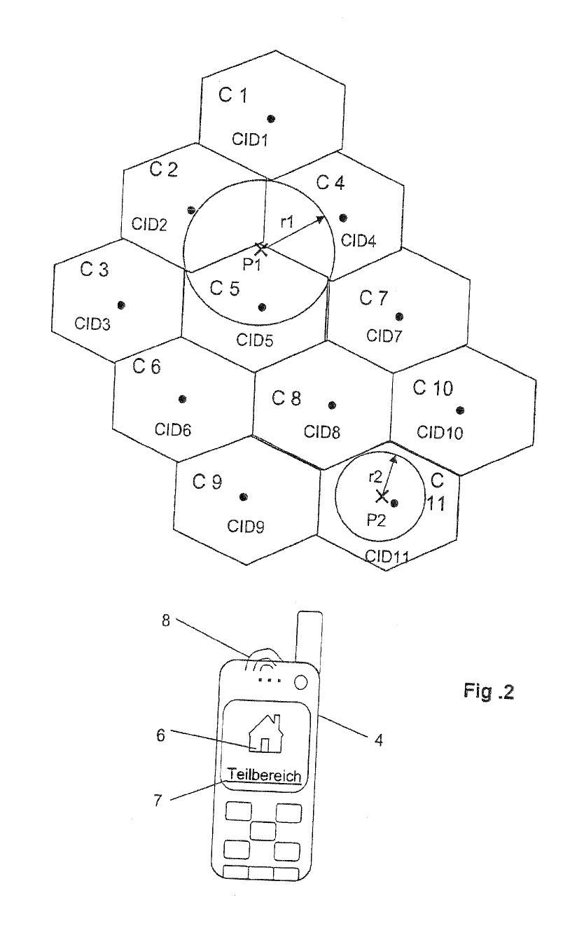

FIG. 2 shows a schematic depiction of a section of the cell structure of a cellular mobile communications network with two defined subareas.

As one can see from FIG. 2, a cellular mobile communications system comprises a multitude of radio cells C1-C11. Each radio cell C1-C11 is supplied with radio signals by at least one base station (fixed radio station). The base stations are represented by a black dot in each radio cell.

The inventive solution essentially consists of two parts:

1. Advance Calculation of the Required Geographic Data:
An advance calculation of geographic locations, i.e., a calculation as to which terminal is to display a geographic visualization in which cell region, is performed per subscriber. The cell regions do not need to be contiguous.

2. Visualization on the Communications Terminal:
The location of the communications terminal within a defined subscriber area is verified and displayed to the subscriber.

1. Calculation of the Geographic Data

Reference now being made to FIG. 1 the required geographic calculations are performed offline in a network element 1 of the communications system. Each mobile telephone subscriber can define personal subscriber areas in which he can communicate at special rates or table advantage of special communications services. A subscriber area of this type is intended to be created, for example, around a subscriber's place of residence.

Reference now being made to FIG. 2, the place of residence of a subscriber is defined by the geographic point P1. The associated subarea is then established by the network operator as a circular area with the center point P1 and specified radius r1. In the network element 1, relevant mobile radio cells for the desired subscriber area, i.e., those radio cells that are located at least partially within the circular area P1, r1, are now identified with the aid of network planning maps. In the depicted example, these are the radio cells C2, C4 and C5. Then the associated cell identifications (cell IDs) CID2 CID4. and CID5 are determined. The subscriber region that was determined for the subscriber, as defined by the radio cells C2, C4, and C5 with the cell identifications CID2, CID4, and CID5, is stored together with other subscriber data in a database 2. The determined cell identifications CID2, CID4 and CID5 are then transmitted via the base station subsystem 3 (BSS) of the mobile communications network via the air interface (OTA: over the air) to the communications terminal 4 and subscriber identification module 5 (SIM card) of the subscriber and stored there.

The database 2 contains data of all subscribers for whom a subscriber region was established, the associated cell identifications. and information as to whether the download to the SIM card 5 of the subscriber was successful.

Transmission of the cell identifications can be repeated if the communications terminal 4 or SIM card 5 can temporarily not be reached. The base station subsystem 3 receives an acknowledgement from the SIM card 5 if the download was successful, which is then transmitted to the network element 1.

Before the service can be used, a one-time download of a SIM application is required per subscriber for the display of geographic information. This application is transmitted in the form of an executable pro-ram code from the network element 1 via the base station subsystem 3 to the communications terminal 4 and SIM card 5 and executed there.

2. Visualization

On the SIM card 5 the SIM application continually checks, in which radio cell the communications terminal 4 is currently located. In a manner known per se each base station continually sends out a unique cell identification in the radio cell that it supplies, which can be received and analyzed by the communications terminal 4. The SIM card 5 then checks whether the cell identification of the current radio cell, for example radio cell C2 with CID2, corresponds with one of the stored cell identifications CID2, CID4, CIDS assigned to the subscriber area. If a correspondence is determined, a visualization takes place in the form of a symbol 6 and/or text 7 on the display of the communications terminal 4 (FIG. 2). The subscriber is thus being informed that he is located within his personal subscriber area. In addition to, or alternatively to the visualization an acoustic signal 8 may be emitted to the subscriber as well.

The SIM application compares, both during every log-in of the communications terminal to the communications network as well as during each change of location of the communications terminal 4, the respective current cell identifications to which the terminal is currently logged-in with the cell identifications that are stored on the SIM card 5. If they correspond, the visualization begins. If they no longer correspond, the visualization ends (in the example: in cells C2, C4, C5 the symbol lights up, in the other cells it is switched off).

In accordance with the invention, it is possible to define not only one subscriber area per subscriber, but multiple subscriber areas as well. In FIG. 2, an additional subscriber area P2, r2 is depicted, which is assigned to the radio cell C11 with the cell identification CID11.

All of the utilized functions are standard SIM toolkit functions, so that no technical changes to the communications terminal or SIM card need to be made.

1. A method for operating a mobile communications system, which comprises a multitude of radio cells (C1-C11) and at least one mobile communications terminal (4) with a subscriber identification module (5), the operation ensuing according to the whereabouts of the communications terminal and comprising the following steps:
a) establishing at least one subscriber area (P1, r1) within a geographic total area covered by the mobile communications system;
b) determining those radio cells that are located at least partially within the subscriber area;
c) transmitting the cell identifications (CID) of the determined radio cells to the communications terminal (4) and the subscriber identification module (5);
d) storing the cell identifications in the subscriber identification module;
e) comparing whether the cell identifications of the radio cells currently serving the communications terminal correspond with the cell identifications stored in the subscriber module; and
f) switching to a special operating mode assigned to the subscriber area, if the comparison has determined a correspondence of a given current cell identification with at least one stored cell identification.

2. A method according to claim 1, wherein, in the special operating mode, information is provided to the user that the communications terminal (4) is located within the subscriber area.

3. A method according to claim 2, wherein the information to the user is provided by means of a visual indication (6; 7) on a display of the communications terminal.

4. A method according to claim 2, wherein the information to the user is provided by means of an acoustic signal (8) that is emitted by the communications terminal (4).

5. A method according to claim 1, further comprising establishing a plurality of non-contiguous subscriber areas (P1, r1; P2, r2).

6. A method according to claim 1, wherein the steps a), b), and c) are performed in/by at least one network element (1) of the communications system.

7. A method according to claim 1, wherein the steps d), e), and f) are performed by the communications terminal (4) and/or by the subscriber identification module (5).

8. A method according to claim 1, wherein a program code is used to perform the steps d), e), and f).

9. A method according to claim 8, wherein the program code is transmitted from the communications system via the communications terminal (4) to the subscriber identification module (5), which program code is processed by the subscriber identification module.

10. A method according to claim 1, wherein the steps e) and f) are performed at least during each log-in of the communications terminal (4) to the communications system and during each change of location of the communications terminal from one radio cell to another radio cell.

11. A method according to claim 1, wherein the cell identification is determined by a cell identifier, CID, and/or by a location area identifier, LAI.

12. A method according to claim 1, wherein provision is made in the special operating mode for the use of certain communication services and communication rates assigned to the operating mode.

13. A mobile communications system comprising a multitude of radio cells (C1-C11) and at least one communications terminal (4) with a subscriber identification module (5), the communications system being operated according to the whereabouts of the communications terminal and comprising the following:
a) means for establishing at least one geographic subscriber area (P1, r1) within a geographic total area covered by the mobile communications system;
b) means for determining those radio cells that are located at least partially within the subscriber area;
c) means for transmitting the cell identifications (CID) of the determined radio cells to the communications terminal;
d) means for storing the cell identifications in the subscriber identification module;
e) means for comparing the cell identifications of the radio cells currently serving the communications terminal with the cell identifications that are stored in the subscriber identification module; and
f) means for operating the communications terminal in a special operating mode assigned to the subscriber area, if the comparison shows the correspondence of a current cell identification with at least one stored cell identification.

14. A communications system according to claim 13, wherein the communications terminal (4) incorporates means for informing the user that the communications terminal is located within the subscriber area.

15. A communications system according to claim 14, these wherein the means for informing comprise visual means (6; 7).

16. A communications system according to claim 14, wherein the means for informing comprise acoustic means (8).

17. A communications system according to claim 13, wherein multiple non-contiguous subscriber areas (P1, r1; P2, r2) are established.

18. A communications system according to claim 13, wherein the means a), b), and c) are disposed in at least one network element (1) of the communications system.

19. A communications system according to claim 13, wherein the means d), e) and f) are disposed in the communications terminal (4) and/or in the subscriber identification module (5).

20. A communications system according to claim 13, wherein, to perform the steps d), e) and f), a corresponding program code is stored in the subscriber identification module (5).

21. A communications system according to claim 13, wherein the cell identifications comprise a cell identifier, CID, and/or a location area identifier, LAI.

22. A communications system according to claim 13, wherein certain communication services and communication tariffs are assigned to the special operating mode.
